(19) United States
(12) Patent Application Publication
(10) Pub. No.: US 2026/0241505 A1
(43) Pub. Date: Aug. 20, 2026

(54) COMPUTER NUMERICAL CONTROL LATHE LOADING AND UNLOADING MACHINE CAPABLE OF AUTOMATIC MATERIAL OVERTURNING

(71) Applicant: Shenzhen FSJ Intelligent Technical Co., Ltd., Shenzhen, Guangdong (CN)

(72) Inventor: Xuehong Liu, Shenzhen, Guangdong (CN)

(21) Appl. No.: 18/870,298

(22) PCT Filed: Apr. 27, 2023
(86) PCT No.: PCT/CN2023/091136

§ 371 Date: Nov. 27, 2024

(30) Foreign Application Priority Data
Jun. 1, 2022 (CN) 202210617700.X

(51) Int. Cl. B23Q 7/04; B25J 9/00; B25J 9/02

(52) U.S. Cl. CPC B23Q 7/043; B25J 9/0075; B25J 9/023; B23Q 2707/003

(57) ABSTRACT

The present invention discloses a computer numerical control lathe loading & unloading machine capable of automatic material overturning, belonging to the field of mechanical processing, and in this solution, the computer numerical control lathe loading & unloading machine capable of automatic material overturning can realize the following beneficial effects: the computer numerical control lathe loading & unloading machine capable of automatic material overturning can complete the automatic loading & unloading of workpieces and the automatic overturning of processed surfaces during process conversion through the modified clamping jaw grasping mechanism of manipulator and the automatic processed surface overturning mechanism added on the material preparation rack; assisted by the automatic cooperation of clamping jaw grasping mechanism, the computer numerical control lathe loading & unloading machine capable of automatic material overturning significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

### TECHNICAL FIELD

The present invention relates to the field of mechanical processing, and more specifically, to a computer numerical control lathe loading & unloading machine capable of automatic material overturning.

### BACKGROUND

computer numerical control lathe loading & unloading machine is composed of a truss manipulator, a clamping jaw grasping mechanism on the manipulator, and a material preparation rack outside the computer numerical control lathe, and works as follows: grasp the workpiece to be processed to the workpiece clamping point at the chuck (or other clamping mechanism) of computer numerical control lathe using the clamping jaw grasping mechanism on the truss manipulator, take away the processed product (no processed product for the first time), place and clamp the product to be processed, and the truss manipulator leaves the computer numerical control lathe to place the workpiece back on the workpiece tray, repeating the above cycle. Traditional computer numerical control lathe loading & unloading machine can only complete the clamping of one processed surface, and cannot alone complete the production of multi process workpieces, or depends on the manual turning of workpiece to produce workpieces with multiple processing steps on a single machine, resulting in high labor costs, low production efficiency, and insufficient utilization of the machine; or the use of a workpiece logistics and distribution system leads to a complex and large process, too much occupied space and difficult implementation, as well as high cost; or the combined use of multiple computer numerical control lathes and loading & unloading truss manipulators result in high costs and uneven machine ratios, leading to idle machines and slower workpiece circulation.

### SUMMARY

### 1. Technical Problems to be Solved

In response to the problems in the prior art, the present invention aims to provide a computer numerical control lathe loading & unloading machine capable of automatic material overturning that can realize the following beneficial effects: the computer numerical control lathe loading & unloading machine capable of automatic material overturning can complete the automatic loading & unloading of workpieces and the automatic overturning of processed surfaces during process conversion through the modified clamping jaw grasping mechanism of manipulator and the automatic processed surface overturning mechanism added on the material preparation rack; assisted by the automatic cooperation of clamping jaw grasping mechanism, the computer numerical control lathe loading & unloading machine capable of automatic material overturning significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

### 2. Technical Solution

To address the above problems, the present invention adopts the following technical solution.
a computer numerical control lathe loading & unloading machine capable of automatic material overturning comprises a truss manipulator, wherein the truss manipulator is provided with a clamping jaw grasping mechanism, a material preparation rack is installed on the outer end of the truss manipulator, and a teaching device is installed on the outer end of the material preparation rack, realizing the following beneficial effects of the computer numerical control lathe loading & unloading machine capable of automatic material overturning: the computer numerical control lathe loading & unloading machine capable of automatic material overturning can complete the automatic loading & unloading of workpieces and the automatic overturning of processed surfaces during process conversion through the modified clamping jaw grasping mechanism of manipulator and the automatic processed surface overturning mechanism added on the material preparation rack; assisted by the automatic cooperation of clamping jaw grasping mechanism, the computer numerical control lathe loading & unloading machine capable of automatic material overturning significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

In further, the truss manipulator comprises a first fixing bracket, a first guide rail and a second fixing bracket (material preparation rack) connected to the first fixing bracket, a first movable bracket connected to the first guide rail (for horizontal movement along the left and right X-axis, provided with the first movable bracket power mechanism), a second guide rail connected to the first movable bracket, a second movable bracket connected to the second guide rail (for vertical movement along the front and rear Y-axis, provided with the second movable bracket power mechanism), a third guide rail connected to the second movable bracket, a third movable bracket connected to the third guide rail (for vertical movement along the up and down Z-axis, provided with the third movable bracket power mechanism), a first rotating mechanism (having the first rotating mechanism power mechanism) is provided on the third movable bracket, and the first rotating mechanism is provided with the first, second and third clamping jaw grasping mechanism (having the first, second, and third clamping jaws); the third clamping jaw grasping mechanism is disposed on the first telescopic mechanism (having a power mechanism for the first telescopic mechanism).

In further, the material preparation rack is the second fixing bracket, equipped with an automatic process surface overturning mechanism and material tray I.

In further, the material preparation rack comprises a second fixing bracket, and the second fixing bracket is provided with a second telescopic mechanism (having a power mechanism for the corresponding second telescopic mechanism) and material tray I, II, and III; the second telescopic mechanism is provided with a second rotating mechanism (having a power mechanism for the corresponding second rotating mechanism), and the second rotating mechanism is provided with a fourth clamping jaw grasping mechanism.

In further, the material preparation rack may further comprise a second fixing bracket, and the second fixing bracket is provided with a second telescopic mechanism (having a power mechanism for the corresponding second telescopic mechanism), a second rotating mechanism (having a power mechanism for the corresponding second rotating mechanism), a fourth clamping jaw grasping mechanism (having the fourth clamping jaw), and material tray I; the second telescopic mechanism is provided with a third telescopic mechanism (having a power mechanism for the corresponding third telescopic mechanism) and material tray II; material tray I and II are designed based on the number of workpiece processing steps, processing size, processing time, manual handling capacity, and robot handling capacity.

### 3. Beneficial Effects

Compared to prior art, the present invention has the following advantages:

This solution can realize the beneficial effects of computer numerical control lathe loading & unloading machine capable of automatic material overturning: the computer numerical control lathe loading & unloading machine capable of automatic material overturning can complete the automatic loading & unloading of workpieces and the automatic overturning of processed surfaces during process conversion through the modified clamping jaw grasping mechanism of manipulator and the automatic processed surface overturning mechanism added on the material preparation rack; assisted by the automatic cooperation of clamping jaw grasping mechanism, the computer numerical control lathe loading & unloading machine capable of automatic material overturning significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

### BRIEF DESCRIPTION OF THE DRAWINGS

FIG. 1 is an overall perspective view of present invention;

FIG. 2 is a perspective view of truss manipulator part of present invention;

FIG. 3 is a perspective view of the material preparation rack part of present invention;

FIG. 4 is an exploded view of the second fixing bracket part of present invention;

FIG. 5 is a perspective view of the second material preparation rack part of present invention;

FIG. 6 is an exploded view of the second fixing bracket part of the second embodiment of present invention;

FIG. 7 is a perspective view of the clamping jaw grasping mechanism of present invention;

FIG. 8 is an exploded view of the clamping jaw grasping mechanism of present invention.

The numbering in the figure indicates:
1. Material preparation rack; 101. Second fixing bracket; 102. Material tray II; 103. Second telescopic mechanism; 104. Power mechanism for second telescopic mechanism; 105. Power mechanism for second rotating mechanism; 106. Second rotating mechanism; 107. Fourth clamping jaw; 108. Material tray III; 109. Material tray I; 110. Material; 2. Truss manipulator; 3. Teaching device; 4. Clamping jaw grasping mechanism; 401. Power mechanism for first rotating mechanism; 402. First clamping jaw; 403. First rotating mechanism; 404. Second clamping jaw; 405. First telescopic mechanism; 406. Power mechanism for first telescopic mechanism; 407. Third clamping jaw, 5. computer numerical control lathe;

### DETAILED DESCRIPTION OF EMBODIMENTS

The technical solutions in the embodiments of the present invention will be described clearly and completely in conjunction with the accompanying drawings of the embodiments of the present invention. Obviously, the described embodiments are only a part of the embodiments of the present invention, rather than all the embodiments. Based on the embodiments of the present invention, all other embodiments obtained by those of ordinary skill in the art without creative work shall fall within the protection scope of the present invention.

In the description of the present invention, it should be noted that the terms “up”, “down”, “inside”, “outside”, “top/bottom”, etc. indicate orientation or position relationships based on the orientation or position relationships shown in the accompanying drawings, only for the convenience of describing the present invention and simplifying the description, and do not indicate or imply that the device or element referred to must have a specific orientation, be constructed and operated in a specific orientation, and therefore cannot be understood as limiting the present invention. In addition, the terms “first” and “second” are only used for descriptive purposes and cannot be understood as indicating or implying relative importance.

In the description of the present invention, it should be noted that unless otherwise specified and limited, the terms “installation”, “provided with”, “sleeved/connected with”, “connection”, etc. should be broadly understood and, for example, “connection” can be a fixed connection, a detachable connection, or an integral connection; and can be a mechanical connection or an electrical connection; can be direct connection, indirect connection through an intermediate medium, or internal connection between two components. The person having ordinary skill in the art can understand the specific meanings of the above terms in the present invention in specific situations.

### Embodiment 1

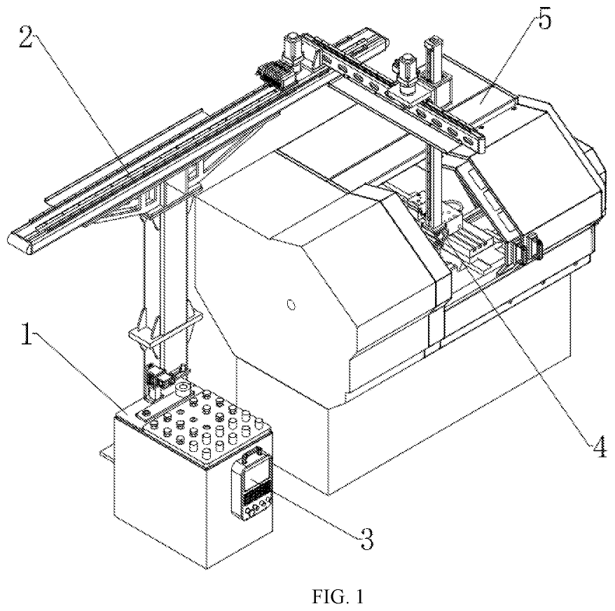

As shown in FIG. 1, a computer numerical control lathe loading & unloading machine capable of automatic material overturning comprises a truss manipulator, wherein the truss manipulator is provided with a clamping jaw grasping mechanism, a material preparation rack is installed on the outer end of the truss manipulator, and a teaching device is installed on the outer end of the material preparation rack, realizing the following beneficial effects of the computer numerical control lathe loading & unloading machine capable of automatic material overturning: the computer numerical control lathe loading & unloading machine capable of automatic material overturning can complete the automatic loading & unloading of workpieces and the automatic overturning of processed surfaces during process conversion through the modified clamping jaw grasping mechanism of manipulator and the automatic processed surface overturning mechanism added on the material preparation rack; assisted by the automatic cooperation of clamping jaw grasping mechanism, the computer numerical control lathe loading & unloading machine capable of automatic material overturning significantly saves manpower and effort without manual turning of workpieces, and can complete the production of multi process products on a single machine, with less flow of processing technology, less workpiece stacking space and retention, free from the annoyance of uneven machine proportioning; It also supports round-the-clock operation of the machine at low cost and maximum production capacity, and relieve the processing industry of the trouble of difficult personnel management and uncontrollable costs.

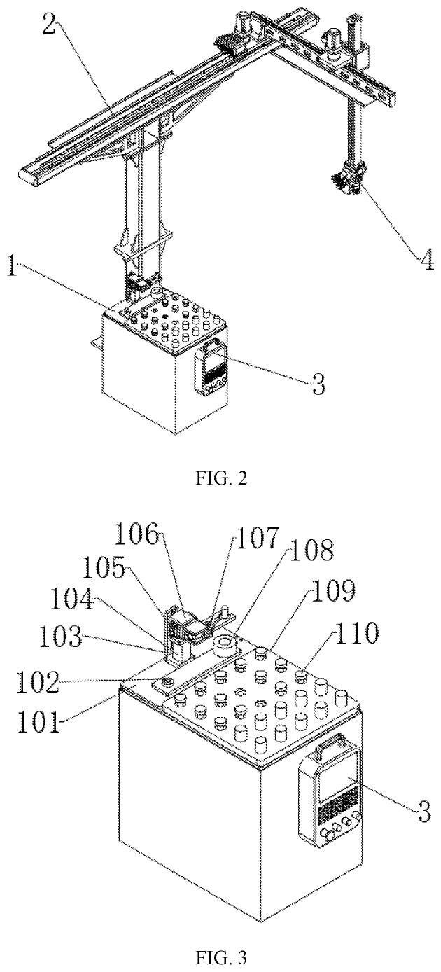

As shown in FIG. 1-2, the truss manipulator comprises a first fixing bracket, a first guide rail and a second fixing bracket (material preparation rack) connected to the first fixing bracket, a first movable bracket connected to the first guide rail (for horizontal movement along the left and right X-axis, provided with the first movable bracket power mechanism), a second guide rail connected to the first movable bracket, a second movable bracket connected to the second guide rail (for vertical movement along the front and rear Y-axis, provided with the second movable bracket power mechanism), a third guide rail connected to the second movable bracket, a third movable bracket connected to the third guide rail (for vertical movement along the up and down Z-axis, provided with the third movable bracket power mechanism), a first rotating mechanism (having a power mechanism for the first rotating mechanism) is provided on the third movable bracket, and the first rotating mechanism is provided with the first, second and third clamping jaw grasping mechanism (having the first, second, and third clamping jaws); the third clamping jaw grasping mechanism is disposed on the first telescopic mechanism (having a power mechanism for the first telescopic mechanism).

As shown in FIG. 2-3, the material preparation rack is the second fixing bracket, equipped with an automatic process surface overturning mechanism and material tray I.

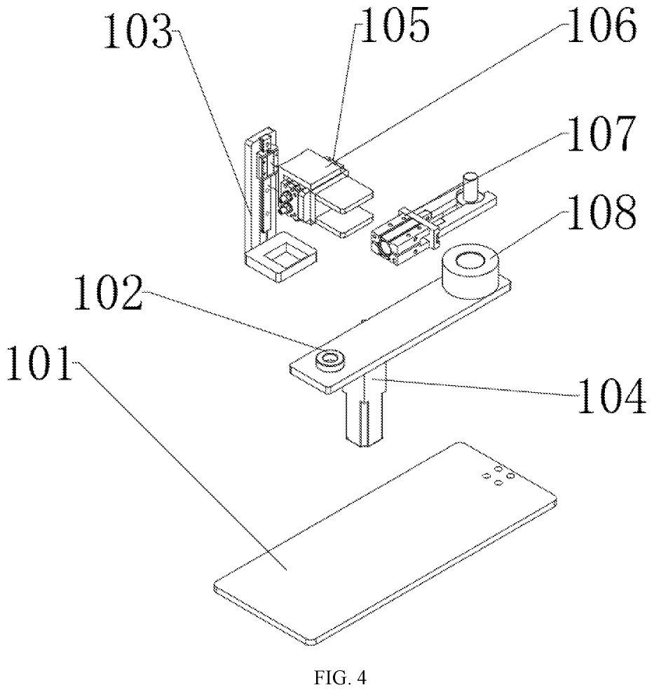

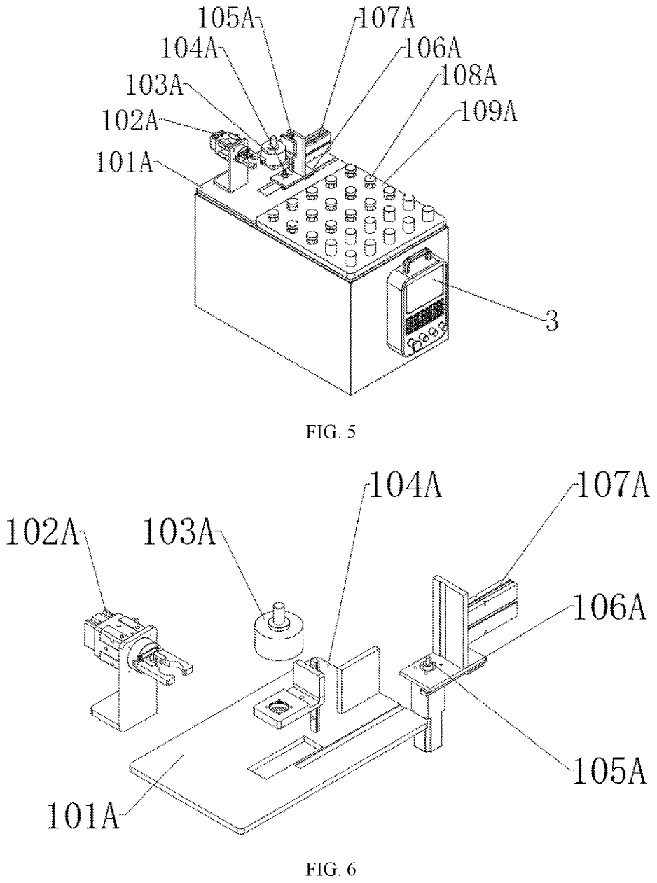

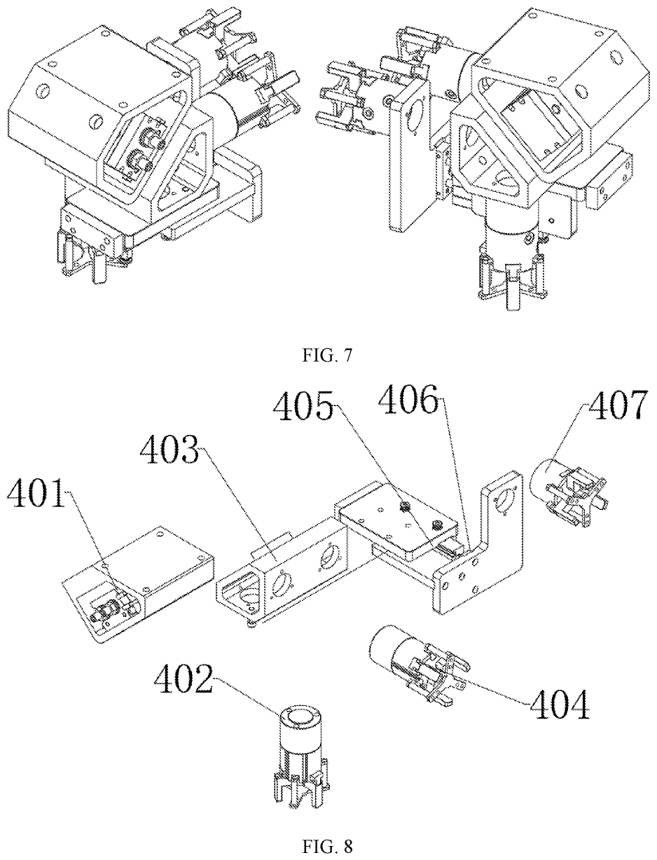

As shown in FIG. 3-4, the material preparation rack comprises a second fixing bracket, and the second fixing bracket is provided with a second telescopic mechanism (having a power mechanism for the corresponding second telescopic mechanism) and material tray I, II, and III; the second telescopic mechanism is provided with a second rotating mechanism (having a power mechanism for the corresponding second rotating mechanism), and the second rotating mechanism is provided with a fourth clamping jaw grasping mechanism; the material preparation rack may further comprise a second fixing bracket, and the second fixing bracket is provided with a second telescopic mechanism (having a power mechanism for the corresponding second telescopic mechanism), a second rotating mechanism (having a power mechanism for the corresponding second rotating mechanism), a fourth clamping jaw grasping mechanism (having the fourth clamping jaw), and material tray I; the second telescopic mechanism is provided with a third telescopic mechanism (having a power mechanism for the corresponding third telescopic mechanism) and material tray II; material tray I and II are designed based on the number of workpiece processing steps, processing size, processing time, manual handling capacity, and robot handling capacity.

The computer numerical control lathe loading & unloading machine capable of automatic material overturning is designed with two types of automatic overturning mechanisms for machining surfaces, which are selected according to the actual situation and explained as follows:

The computer numerical control lathe loading & unloading machine capable of automatic material overturning of the first structure performs loading & unloading for computer numerical control lathe according to the following process route:
\textcircled{1} Manually place unprocessed workpieces on material tray I of material preparation rack;
\textcircled{2} Truss manipulator grasps unprocessed workpiece A from material tray I and transfers it to the vicinity of the chuck of computer numerical control lathe, takes away the processed workpiece (no processed workpiece for the first time) and places unprocessed workpiece A on the chuck which will clamp automatically;
\textcircled{3} Truss manipulator leaves computer numerical control lathe and moves to material tray II;
\textcircled{4} When computer numerical control lathe is processing workpiece, truss manipulator places processed workpieces (no processed workpieces for the first time) onto material tray II;
\textcircled{5} The processed workpiece A1 is placed on material tray III through the automatic process surface overturning mechanism (no processed workpiece for the first time), meeting the requirement of turning process surface by 180° (no processed workpiece for the first time);
\textcircled{6} Truss manipulator grasps turned workpieces A1 (no processed workpiece for the first time) from material tray III, and places it on material tray I;
\textcircled{7} Truss manipulator grasps unprocessed workpiece B from material tray I and moves it outside the computer numerical control lathe;
\textcircled{8} After computer numerical control lathe completes processing, three-axis manipulator moves to the chuck of computer numerical control lathe, takes away processed workpiece A1, and places unprocessed workpiece B on the chuck which will clamp automatically;
\textcircled{9} When computer numerical control lathe is processing workpiece, truss manipulator places processed workpiece A1 onto material tray II;
\textcircled{10} The processed workpiece A1 is placed on material tray III through the automatic process surface overturning mechanism, meeting the requirement of turning process surface by 180°;
\textcircled{11} Truss manipulator grasps turned workpieces A1 from material tray III, and places it on material tray I;

Continuously repeat the above cycle until all workpieces on the material tray have completed all processes, without manual turning, saving time and effort, and the production of finished products is automatically completed by a single machine.

### Embodiment 2

The computer numerical control lathe loading & unloading machine capable of automatic material overturning of second structure of is shown in FIG. 2, with the following transmission relationship:

The first guide rail and material preparation rack are installed on the first fixing bracket, the second guide rail is installed on the first guide rail, and the third guide rail is installed on the second guide rail; the first, second, and third guide rails make linear motion and move according to program settings based on 3-axis linkage; the first rotating mechanism installed on the mounting flange of the third guide rail moves along with the guide rail; the first rotating mechanism rotates 180 degrees and can convert the positions of the three clamping jaws installed on the mechanism; the first telescopic mechanism installed on the first rotating mechanism can drive the third clamping jaw for position adjustment; three clamping jaws, namely the first, second, and third clamping jaws, are used to grasp and place the processed workpiece; material tray I, fourth clamp, and second telescopic mechanism are installed on the second fixing bracket, and the second telescopic mechanism can drive the third telescopic mechanism on the mechanism for position adjustment; the fourth clamping jaw can rotate 180° to grasp and place processed workpiece; the third telescopic mechanism performs linear motion and can drive material tray II on the drive mechanism for position adjustment.

The computer numerical control lathe loading & unloading machine capable of automatic material overturning of the second structure performs loading & unloading for computer numerical control lathe according to the following process route:
\textcircled{1} Manually place unprocessed workpieces on material tray I of material preparation rack;
\textcircled{2} Truss manipulator grasps unprocessed workpiece A from material tray I and transfers it to the vicinity of the chuck of computer numerical control lathe, takes away the processed workpiece (no processed workpiece for the first time) and places unprocessed workpiece A on the chuck which will clamp automatically;
\textcircled{3} Truss manipulator leaves computer numerical control lathe and moves to material tray II;
\textcircled{4} When computer numerical control lathe is processing workpiece, truss manipulator places processed workpieces (no processed workpieces for the first time) onto material tray II;
\textcircled{5} Meet the requirement of turning process surface by 18020 (no processed workpiece for the first time) through the automatic process surface overturning mechanism;
\textcircled{6} Truss manipulator grasps turned workpieces A1 (no processed workpiece for the first time) from material tray II, and places it on material tray I;
\textcircled{7} Truss manipulator grasps the second unprocessed workpiece B from material tray I and moves it outside the computer numerical control lathe;
\textcircled{8} After computer numerical control lathe completes processing, truss manipulator moves to the vicinity of chuck of computer numerical control lathe, takes away processed workpiece A1, places unprocessed workpiece B on the chuck which will clamp automatically;
\textcircled{9} Truss manipulator leaves computer numerical control lathe and moves to the vicinity of material tray II;
\textcircled{10} When computer numerical control lathe is processing workpiece, truss manipulator places processed workpiece A1 onto material tray II;
\textcircled{11} The processed workpiece A1 is placed on material tray III through the automatic process surface overturning mechanism, meeting the requirement of turning process surface by 180°;
\textcircled{12} Truss manipulator grasps turned workpieces A1 from material tray III, and places it on material tray I;

Continuously repeat the above cycle until all workpieces on the material tray have completed all processes, without manual turning, saving time and effort, and the production of finished products is automatically completed by a single machine.

The process routes
\textcircled{5} and
\textcircled{11} of the above two types of process surface automatic overturning mechanisms are selected according to the “combined working method of automatic overturning of process surfaces and clamping jaw grasping” shown in FIG. 15 and the requirements of workpiece processing, and process surfaces are turned by the software system program of the computer numerical control lathe loading & unloading machine capable of automatic material overturning. The combined working method of automatic overturning of process surfaces and clamping jaw grasping will be printed and displayed on the main surface of computer numerical control lathe loading & unloading machine capable of automatic material overturning, facilitating the use by operators.

The scope of protection of the present invention is not limited to the above embodiments, which are only the preferred ones of the present invention. Any equivalent substitution or change made by any person skilled in the art within the technical scope disclosed in the present invention based on the technical solution and its improved concept of the present invention shall be covered within the scope of protection of the present invention.

1. a computer numerical control lathe loading & unloading machine capable of automatic material overturning, comprising a truss manipulator (2), wherein the truss manipulator (2) is provided with a clamping jaw grasping mechanism (4), a material preparation rack (1) is installed on the outer end of the truss manipulator (2), and a teaching device (3) is installed on the outer end of the material preparation rack (1).

2. The computer numerical control lathe loading & unloading machine capable of automatic material overturning according to claim 1, wherein the truss manipulator (2) comprises a first fixing bracket, a first guide rail and a second fixing bracket (material preparation rack) connected to the first fixing bracket, a first movable bracket connected to the first guide rail (for horizontal movement along the left and right X-axis, provided with the first movable bracket power mechanism), a second guide rail connected to the first movable bracket, a second movable bracket connected to the second guide rail (for vertical movement along the front and rear Y-axis, provided with the second movable bracket power mechanism), a third guide rail connected to the second movable bracket, a third movable bracket connected to the third guide rail (for vertical movement along the up and down Z-axis, provided with the third movable bracket power mechanism), a first rotating mechanism (having a power mechanism for the first rotating mechanism) is provided on the third movable bracket, and the first rotating mechanism is provided with the first, second and third clamping jaw grasping mechanism (having the first, second, and third clamping jaws); the third clamping jaw grasping mechanism is disposed on the first telescopic mechanism (having a power mechanism for the first telescopic mechanism).

3. The computer numerical control lathe loading & unloading machine capable of automatic material overturning according to claim 1, wherein the material preparation rack is the second fixing bracket, equipped with an automatic process surface overturning mechanism and material tray I.

4. The computer numerical control lathe loading & unloading machine capable of automatic material overturning according to claim 1, wherein the material preparation rack (1) comprises a second fixing bracket, and the second fixing bracket is provided with a second telescopic mechanism (having a power mechanism for the corresponding second telescopic mechanism) and material tray I, II, and III; the second telescopic mechanism is provided with a second rotating mechanism (having a power mechanism for the corresponding second rotating mechanism), and the second rotating mechanism is provided with a fourth clamping jaw grasping mechanism.

5. The computer numerical control lathe loading & unloading machine capable of automatic material overturning according to claim 1, wherein the material preparation rack (1) may further comprise a second fixing bracket, and the second fixing bracket is provided with a second telescopic mechanism (having a power mechanism for the corresponding second telescopic mechanism), a second rotating mechanism (having a power mechanism for the corresponding second rotating mechanism), a fourth clamping jaw grasping mechanism (having the fourth clamping jaw), and material tray I; the second telescopic mechanism is provided with a third telescopic mechanism (having a power mechanism for the corresponding third telescopic mechanism) and material tray II; material tray I and II are designed based on the number of workpiece processing steps, processing size, processing time, manual handling capacity, and robot handling capacity.
